(19) United States
(12) Patent Application Publication
(10) Pub. No.: US 2025/0011191 A1
(43) Pub. Date: Jan. 9, 2025

(54) SYSTEM AND METHOD FOR CONTROLLING REMEDIATION CYCLES FOR THE TREATMENT OF AQUATIC FACILITY WATER

(71) Applicant: Truox, Inc., Naples, FL (US)

(72) Inventor: Roy W. Martin, Naples, FL (US)

(21) Appl. No.: 18/893,141

(22) Filed: Sep. 23, 2024

Related U.S. Application Data
(63) Continuation-in-part of application No. 18/817,464, filed on Aug. 28, 2024.
Application No. 18/817,464 is a continuation-in-part of application No. 18/140,882, filed on Apr. 28, 2023.
Application No. 18/140,882 is a continuation-in-part of application No. 18/111,656, filed on Feb. 20, 2023.
Application No. 18/111,656 is a continuation-in-part of application No. 17/988,963, filed on Nov. 17, 2022.
Application No. 17/988,963 is a continuation-in-part of application No. 17/866,823, filed on Jul. 18, 2022.
Application No. 17/866,823 is a continuation-in-part of application No. 17/571,586, filed on Jan. 10, 2022, now Pat. No. 11,999,633.
Application No. 17/571,586 is a continuation-in-part of application No. 17/205,316, filed on Mar. 18, 2021, now Pat. No. 12,037,263.
(60) Provisional application No. 63/536,735, filed on Sep. 6, 2023.

(51) Int. Cl. C02F 1/00; C02F 1/76

(52) U.S. Cl. CPC C02F 1/008; C02F 1/76; C02F 2209/006; C02F 2209/04

(57) ABSTRACT

A system and method for controlling and accelerating a Recovery Remediation cycle for the treatment of water of an aquatic facility for immersion by humans using a process controller programmed to obtain a targeted chlorine dioxide CT Value in the water. The system controls a Recovery Remediation cycle and utilizes a lag-time compensated Ct Value to reduce the time to complete the remediation cycle.

### FIELD OF INVENTION

The invention relates to a system for controlling multiple methods of remediation cycles for the treatment of water of an aquatic facility for immersion by humans. The system controls remediation cycles having different completion time intervals and chlorine dioxide setpoints using a programmable process controller integrated with chemical feed systems and sensors for measuring water chemistry parameters. The system performs a Recovery Remediation cycle that can be completed in less than 30 minutes as well as Routine Remediation cycles comprising a daily remediation cycle while the Aquatic Facility is closed to bathers or continuous 24/7 remediation cycles while the facility is being used by bathers without concern of overfeeding the treatment.

### BACKGROUND

Free chlorine and free bromine are common sanitizers for the treatment of water at aquatic facilities. While effective at controlling bacteria counts in the water, they have limited efficacy against waterborne pathogens that are resistant to the sanitizers such as Cryptosporidium. Free halogens also form undesirable disinfection byproducts (DBPs) that foul the air, cause corrosion, irritation to skin and respiratory system.

Along with chlorine resistant microbiological organisms like Cryptosporidium, other bacterial organisms are chlorine resistant and can form bio-films within the conduit (piping) of the pools circulating system. Some non-limiting examples include: Pseudomonas aeruginosa and Enterocaccus faecium.

The Centers for Disease Control and Prevention has reported waterborne pathogens such as Cryptosporidium are accountable for nearly 80% of all Recreational Water Illness (RWI) in the United States. Combined with bacterial infections and virus, other waterborne pathogens that are resistant to chlorine and/or are embedded in a protective biofilm account for nearly 100% of all Recreational Water Illness (FIG. 1).

Chlorine dioxide is favored over many oxidizing biocides due to its biocide efficacy over a broad pH range, low use rate, biofilm penetration, membrane penetration and high selectivity in contaminated water.

Aquatic facilities experience high bather loading (number of people versus volume of water in the pool) and high oxidant demand. Organic contaminants such as body oils, lotions can adsorb to the piping comprising the water intakes of the circulating system. Globular proteins in saliva, urea and various contaminants that contribute, carbon, nitrogen and sulfur impose a high demand on the disinfectants used to treat the water The byproducts of reactions between these organic compounds and disinfectant result in disinfection byproducts (DBPs). DBPs are familiar to anyone who has experienced a heavily used indoor pool and smelled the chlorine like odor that stings the eyes and worse.

Accumulating DBPs not only reduce water and air quality, it reduces disinfection rates which are indicated by reduced Oxidation Reduction Potential (ORP). Bacteria survive for longer periods and can become entrapped within the organic films lining the piping previously described. Entrapped bacteria thrive in the warm, nutrient rich water resulting in formation of bio-film. It is not uncommon for Aquatic Facility pools to be closed by the Department of Health for measured bacteria plate counts higher than acceptable levels. While super-chlorination removes the bacteria temporarily by killing the bacteria in the water and exposed at the surface of the biofilm, after a week of normal operations the thriving bacteria protected by the bio-film are released to contaminate the water, resulting in another failed test by the Department of health.

Cryptosporidium is a parasite having multiple membranes that make it highly resistant to chlorine. Under normal chlorine concentrations, Cryptosporidium can survive for over 1 week. Undetected, the Cryptosporidium can infect hundreds of people and no-one is to the wiser until reports of sick people visiting hospitals or doctors is reported.

In order to ensure that aquatic facilities are properly protected from waterborne pathogens and address the issue of DBPs, there is a need for remediating the water as well as the entire circulating system of the Aquatic Facility to remove established microbiological organisms and the accumulated oxidant demand. Once the water and circulating system are treated using a Recovery Remediation, then the water needs to be treated using a Routine Remediation to provide a form of prophylactic.

Implementing and controlling Recovery Remediation to rid the water and circulating system of contaminants including pathogens, followed by implementation of Routine Remediation as a preventative treatment sounds straight forward and intuitive. However, the need for significant capital investment for equipment (high and low volume output feeders) or replacement of existing feeders with variable (digital) chemical feed systems integrated with a digital output controller, space for installation of new auxiliary equipment and or safety issues resulting from improper control of chemical feed resulting in the overfeed (output feed systems) while bathers are present brings to light several major hurdles before implementation would be feasible.

The chemical feed systems are typically set to their output setting to provide for Recovery Remediation. Typically, this will be at or near their maximum output setting for the feed systems.

Currently when a fecal release is detected, the pool is closed and hyper-chlorination is performed, raising the chlorine concentration to as much as 50 ppm. When these procedures are performed, the Departments of Health in the U.S. follow the Centers for Disease Control and Prevention guideline requiring a chlorine CT value of 15,300 mg/l×min. With such a high chlorine CT value, the pool is essentially closed for the remainder of the day, costing aquatic facilities such as large Water-Parks significant economic burden.

Recently, the U.S. EPA has approved registration for a new product named Cryptolyte® for remediating the pool water using chlorine dioxide with a Ct value of 160 mg/l×min. Cryptolyte can achieve a 3-log reduction of Cryptosporidium in less than 30 minutes provided the feed system is large enough to increase the concentration of chlorine dioxide quickly to accelerate the remediation cycle.

Another important factor in achieving remediation in a timely fashion is the pool lag-time. The lag-time is the period of time that lapses between beginning the feed of chemical to the pool water and detecting (measuring) the increase of the chemical by the in-line sensor.

During the lag-time period, chemicals are injected into the pool's return header 33 in high concentrations and dispersed into the pool water. During this period the chlorine-resistant pathogens (Cryptosporidium) are being treated with chlorine dioxide, however, because the in-line sensors in line 36 have not detected the chlorine dioxide, the chlorine dioxide Ct value is not being timely credited. Typical lag-time of a pool having a 6 hour turnover rate can range from about 15 to 20 minutes. This is an extensive period of time wherein the Cryptosporidium has been exposed to chlorine dioxide but the calculated chlorine dioxide Ct value does not properly reflect the exposure to chlorine dioxide and is therefore not being credited toward the 160 mg/l×min required by the EPA.

There is a need for compensating the chlorine dioxide CT Value for the exposure to chlorine dioxide that occurs during the lag-time period while chlorine dioxide was being applied to the pool water but no increases in chlorine dioxide concentration were being detected.

U.S. Pat. Nos. 7,922,933, 7,927,509, and 7,976,725 which are herein incorporated by reference in their entirety, disclose a cyclic process for the in-situ generation of chlorine dioxide. The cyclic process utilizes bromide ions that are activated by an oxidant to produce free bromine. The free bromine oxidizes chlorite ions producing chlorine dioxide. Chlorine dioxide inactivates microbiological organisms (i.e. Cryptosporidium). During this process the free bromine and at least some portion of the chlorine dioxide are reduced back to bromide ions and chlorite ions respectively which are recycled back to free bromine and chlorine dioxide utilizing the cyclic process.

My earlier U.S. Published Patent Application Nos. 2019-0300398 and 2020-0346948, which are herein incorporated by reference in their entirety, disclose methods for in-situ generation and stabilization of chlorine dioxide in the water of an aquatic facility using UV activation of chlorite ions.

My earlier U.S. Published Patent Application Nos. 2021-0323838 and 2022-0127164, which are herein incorporated by reference in their entirety, disclose methods for in-situ generation and stabilization of chlorine dioxide in the water of an aquatic facility.

Co-pending application Ser. Nos. 17/571,586, 17/988,963, 17/866,823, 17/205,316, 18/111,656 and 18/140,882 which are herein incorporated by reference in their entirety, disclose methods and a system for controlling remediation cycles, and methods for the in-situ generation of chlorine dioxide.

My earlier U.S. Published Patent Application No. 2021-0323838 and 2022-0127164 use existing process controllers to control the chlorine dioxide concentration in the swimming pool water. The limitations provided by existing swimming pool process controllers are exemplified in the control examples provided. A chemical feed system designed to support Recovery Remediation will overfeed chlorine dioxide using time-based proportional control or ON/OFF control. Therefore, a secondary chemical feed system is required, or the chemical feed system output must be manually adjusted to reduce the feed rate of chlorine dioxide. In the reverse case where the chemical feed systems are designed to support Routine Remediation, they will not provide the chlorine dioxide feed rate to support the Recovery Remediation and complete the remediation within the completion time interval. Furthermore, reducing the chemical feed rate manually can impair the performance of accelerated in-situ generation of chlorine dioxide since the localized high concentrations of reactant chemicals is compromised, with some chemicals being applied while others are not as a result of having different speed and stroke setting on the chemical feed systems (i.e. pumps).

U.S. Pat. No. 4,224,154 discloses a swimming pool chemical control system. The invention discloses a method of time-based proportional control. Referring to column 4, lines 9-27, the controller employs various timers with one short duration timer controlling the ON time, and a second longer duration timer controlling the OFF time. The duration of the ON and OFF time is predetermined.

Co-pending application Ser. No. 18/817,464 filed on Aug. 28, 2024, which is herein incorporated by reference in their entirety, discloses a system for controlling multiple methods of remediation cycles having different completion time intervals using the same chemical feed system.

A method and system are needed to more accurately calculate the actual exposed chlorine dioxide Ct value in order to compensate for the lag-time. Implementation of a lag-time compensation provides the facility utilizing this technology significantly reduced time period required to achieve the targeted chlorine dioxide Ct value of 160 mg/l×min.

### SUMMARY OF THE INVENTION

The invention comprises a method and system for controlling the Recovery Remediation cycle and compensating for the unmeasured chlorine dioxide Ct value that occurs due to the pool system lag-time.

Referring to FIG. 9, T₀ is the time when the Recovery Remediation cycle is initiated and T₁ is the time when the in-line chlorine dioxide sensor detects a measured increase in the chlorine dioxide concentration. T₁ is also the time when the increase in chlorine dioxide is affecting the measured chlorine dioxide Ct value. The lapsed time between T₀ and T₁ is the lag-time. T₂ is the lapsed time (minutes) when the chlorine dioxide setpoint is reached.

One objective of the invention is to compensate for the chlorine dioxide Ct value that occurred during the time period known as the “lag-time” to more accurately reflect the level of inactivation of Cryptosporidium that has occurred during that period.

A first embodiment of the invention relates to a method for accelerating a recovery remediation cycle of water at an aquatic facility for immersion by humans, the method comprising:
providing an integrated system comprising:
   a chlorine dioxide sensor in fluid communication with the water;
   a chlorine dioxide feed system in fluid communication with the water; and
   a process controller in communication with the chlorine dioxide sensor and the chlorine dioxide feed system for measurement and control of chlorine dioxide in the water, wherein the process controller having a chlorine dioxide setpoint and a chlorine dioxide Ct value setpoint;
initiating the recovery remediation cycle;
the process controller feeding the chlorine dioxide from the chlorine dioxide feed system to the water;
the process controller measuring a chlorine dioxide concentration in the water using the chlorine dioxide sensor;
the process controller calculating the chlorine dioxide Ct value until the chlorine dioxide Ct value setpoint is reached;
when a chlorine dioxide setpoint is reached, the process controller calculating a lag-time compensated chlorine dioxide Ct value of the water using the following steps:
subtracting a T₀ chlorine dioxide concentration of the water from a T₂ chlorine dioxide concentration of the water by the process controller to obtain the delta chlorine dioxide concentration;
dividing a delta chlorine dioxide concentration by 2 by the process controller to obtain an average chlorine dioxide concentration;
multiplying the average chlorine dioxide concentration by a time period T₂-T₀ (minutes) by the process controller to obtain a lag-time compensated chlorine dioxide Ct value, wherein T₀ is the time when the recovery remediation cycle is initiated, T₂ is the time lapsed (minutes) when the chlorine dioxide setpoint is reached, and the lag-time compensated chlorine dioxide Ct value reduces time to complete the recovery remediation cycle;
the process controller replacing the calculated Ct value with the lag-time compensated Ct Value and continuing to calculate the chlorine dioxide Ct value, and
when the chlorine dioxide Ct value setpoint is reached the remediation cycle is terminated by the process controller.

In accordance with the first embodiment, wherein the T₀ chlorine dioxide concentration is 0 ppm.

A second embodiment of the invention relates to a system for accelerating the recovery remediation cycle for the treatment of water of an aquatic facility for immersion by humans, the system comprising:
a chlorine dioxide sensor in fluid communication with the water;
a chlorine dioxide feed system in fluid communication with the water; and
a process controller in communication with the chlorine dioxide sensor and the chlorine dioxide feed system for measurement and control of chlorine dioxide in the water;
the process controller is programmed to control the recovery remediation cycle comprising the steps;
having a chlorine dioxide Ct value setpoint;
initiating the recovery remediation cycle;
measuring the lapsed time;
measuring the chlorine dioxide concentration;
calculating a lag-time compensated chlorine dioxide Ct value of the water:
sustaining the concentration of chlorine dioxide until the chlorine dioxide Ct value setpoint of the water is achieved; and
the process controller stopping feeding of the chlorine dioxide from the chlorine dioxide feed system to the water when the chlorine dioxide Ct value setpoint of the water is achieved.

The invention in accordance with the second embodiment wherein the lag-time compensated chlorine dioxide Ct value comprises:
subtracting the T₀ chlorine dioxide concentration from the T₂ chlorine dioxide concentration to obtain the delta chlorine dioxide concentration;
dividing the delta chlorine dioxide concentration by 2 to obtain the average chlorine dioxide concentration;
multiplying the average chlorine dioxide concentration by the time period T₂-T₀ (minutes) to obtain the lag-time compensated chlorine dioxide Ct value;
   T₀ is the time when the Recovery Remediation cycle is initiated, and T₂ is the time lapsed (minutes) when the chlorine dioxide setpoint is reached, and
wherein the lag-time compensated chlorine dioxide Ct value reduces the time to complete the Recovery Remediation cycle.

The second embodiment further includes a system for accelerating a recovery remediation cycle of water at an aquatic facility for immersion by humans comprising:
a chlorine dioxide sensor in fluid communication with the water;
a chlorine dioxide feed system in fluid communication with the water; and
a process controller in communication with the chlorine dioxide sensor and the chlorine dioxide feed system for measurement and control of chlorine dioxide in the water;
wherein the process controller is programmed to have a chlorine dioxide setpoint and a chlorine dioxide Ct value setpoint;
wherein the process controller is programmed to perform the following steps:
feeding the chlorine dioxide from the chlorine dioxide feed system to the water;
measuring a chlorine dioxide concentration in the water using the chlorine dioxide sensor;
calculating the chlorine dioxide Ct value until the chlorine dioxide Ct value setpoint is reached;
when a chlorine dioxide setpoint is reached, calculating a lag-time compensated chlorine dioxide Ct value of the water using the following steps:
subtracting a T₀ chlorine dioxide concentration of the water from a T₂ chlorine dioxide concentration of the water by the process controller to obtain the delta chlorine dioxide concentration;
dividing a delta chlorine dioxide concentration by 2 by the process controller to obtain an average chlorine dioxide concentration;
multiplying the average chlorine dioxide concentration by a time period T₂-T₀ (minutes) by the process controller to obtain a lag-time compensated chlorine dioxide Ct value, wherein T₀ is the time when the recovery remediation cycle is initiated, T₂ is the time lapsed (minutes) when the chlorine dioxide setpoint is reached, and the lag-time compensated chlorine dioxide Ct value reduces time to complete the recovery remediation cycle;
replacing the calculated chlorine dioxide Ct value with the lag-time compensated chlorine dioxide Ct Value and continuing to calculate the chlorine dioxide Ct value, and
when the chlorine dioxide Ct value setpoint is reached the remediation cycle is terminated.

The invention in accordance with the second embodiment, wherein the T₀ chlorine dioxide concentration is 0 ppm.

The process controller can be programmed to set the chlorine dioxide chemical feed system(s) to their maximum output.

The process controller can be programmed for controlling the sanitizer and pH control feed systems using time-based proportional control.

The programmable process controller calculates, records, and stores the chlorine dioxide Ct value of the water. The process controller can also display the chlorine dioxide Ct value. The process controller can be programmed to forecast the time to achieve the targeted chlorine dioxide Ct value of the water. The calculated chlorine dioxide Ct value can be based on the rolling average of the chlorine dioxide concentration. The chlorine dioxide Ct value is calculated at any desired interval, for example every 0.1 to 60 minutes. The chlorine dioxide Ct value can be calculated by:

$$Chlorine dioxide Ct value = [ ( \sum {X}_{n} ) \div n ] \times T$$

Where:
“Xn” is the chlorine dioxide concentration in mg/l (or ppm) recorded at a point in time since beginning the remediation cycle;
“n” is the number of chlorine dioxide values recorded over a period of time since beginning the remediation cycle; and
“T” is the period of time (minutes) that has lapsed since beginning the remediation cycle.

Another suitable option for calculating the chlorine dioxide Ct value is by summation of sampling time intervals. The chlorine dioxide Ct value is calculated at any desired interval, for example every 0.1 to 60 minutes. The chlorine dioxide Ct value can be calculated by:

$$Chlorine dioxide Ct value = \sum [ ( \sum {X}_{n} \div n ) \times T ]$$

Where:
“Xn” is the chlorine dioxide concentration in mg/l (or ppm) recorded at a point in time over the sampling period;
“n” is the number of chlorine dioxide values recorded over the sampling period; and
“T” is the period of time (minutes) that has lapsed over the sampling period.

Any suitable sanitizer sensor can be utilized, such as an ORP sensor or an amperometric sensor for measuring free and/or total chlorine. The system preferably utilizes both ORP and amperometric sensor for measuring the relative concentration of sanitizer.

Chlorine dioxide can be applied using any suitable means of generating and delivering chlorine dioxide. For example, chlorine dioxide can be generated in-situ using accelerated in-situ generation, cyclic process, UV activation of chlorite or their combinations. Methods for in-situ generations using these methods have been disclosed in the referenced prior art.

For outdoor aquatic facilities UV activation of chlorite ions supports chlorine dioxide generation and depletes the chlorite concentration thereby preventing accumulation of an undesirable byproduct in the water.

For indoor aquatic facilities, the preferred method in inhibiting accumulation of chlorite ions in the water is by employing the cyclic process wherein hypobromous acid activates chlorite to produce chlorine dioxide in-situ. The hypobromous acid is reduced to bromide ions, which are then oxidized back to hypobromous acid by further addition of free chlorine.

Chlorine dioxide can also be applied using ex-situ generation using a chlorine dioxide generator. One such example of a suitable chlorine dioxide generator is disclosed in U.S. Pat. No. 9,656,891.

### BRIEF DESCRIPTION OF THE DRAWINGS

FIG. 1 illustrates the Etiology of microbial infections from treated swimming pools provided by the Centers for Disease Control and Prevention.

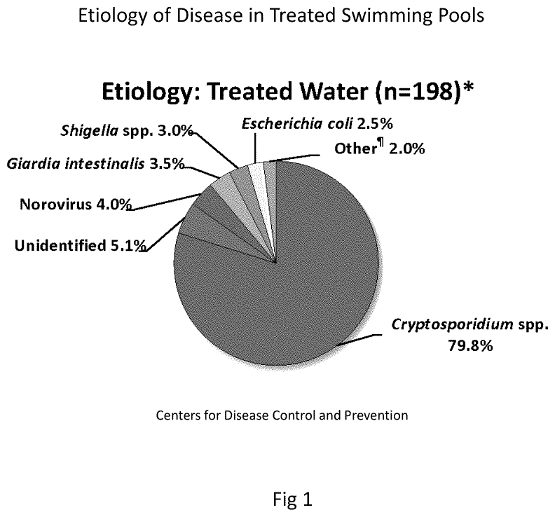

FIG. 2 illustrates the in-situ generation of chlorine dioxide using the cyclic process.

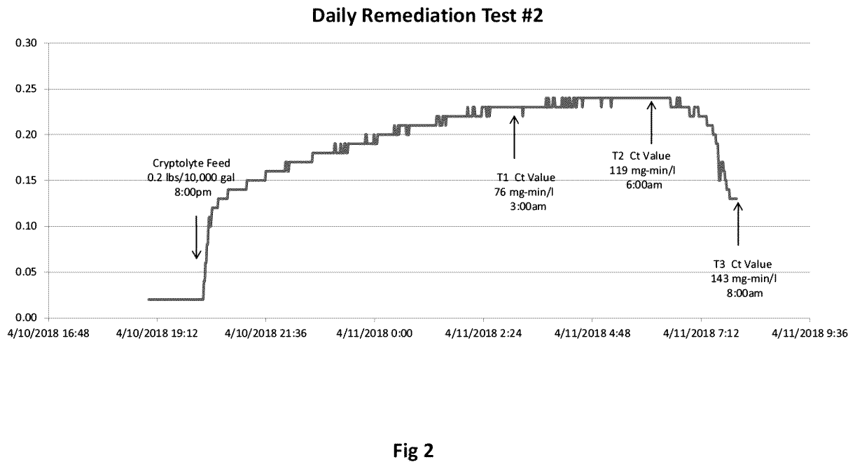

FIG. 3 is the events logs supporting FIG. 2 showing the application of Cryptolyte® (sodium chlorite solution) and the effects on ORP.

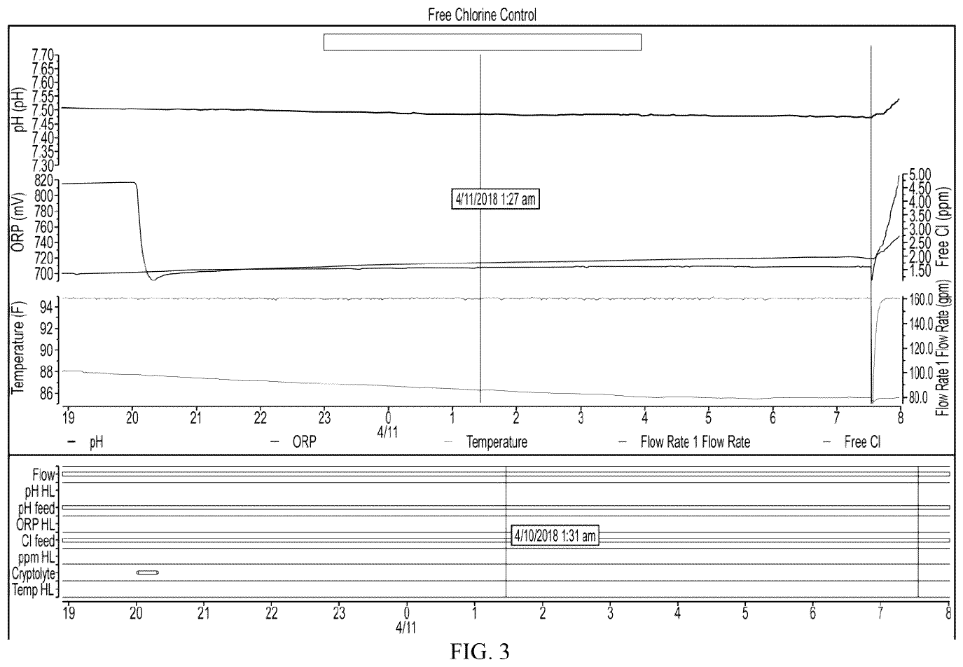

FIG. 4 illustrates a cyclic process for the in-situ generation of chlorine dioxide disclosed in the referenced prior art.

FIG. 5 illustrates the configuration of the integrated process control system as it relates to the circulating system of the aquatic facility. Conduit (33) in which accelerated in-situ generation of chlorine dioxide takes place in an integral part of the pools circulating system, while the pool (4) is where the majority of the in-situ generation of chlorine dioxide will occur as a result of UV activation of chlorite and/or the cyclic process.

FIG. 6 and FIG. 7 illustrate the rapid increase in in-situ generated chlorine dioxide as a result of the accelerated in-situ generation of chlorine dioxide.

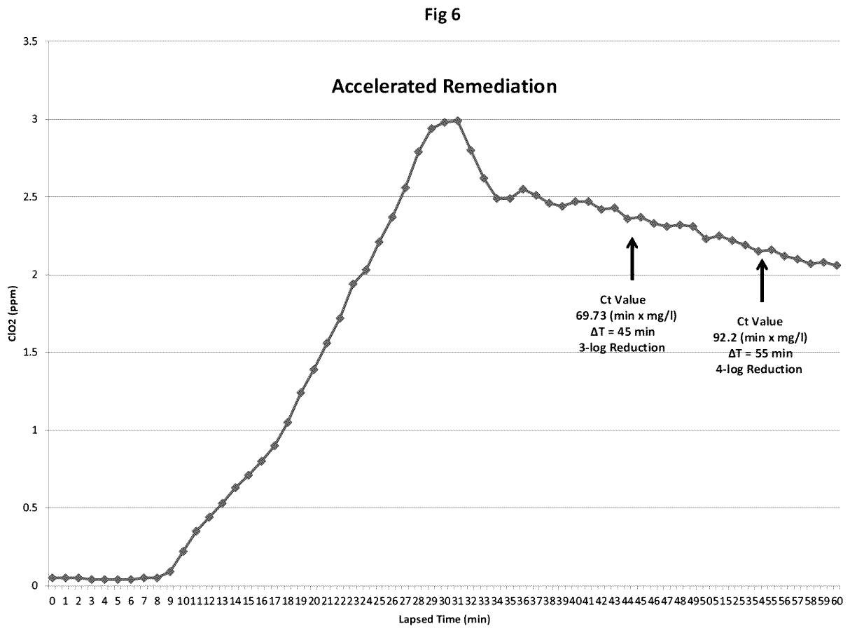

FIG. 7 further illustrates the application of neutralizer to remove residual treatment after completing the remediation.

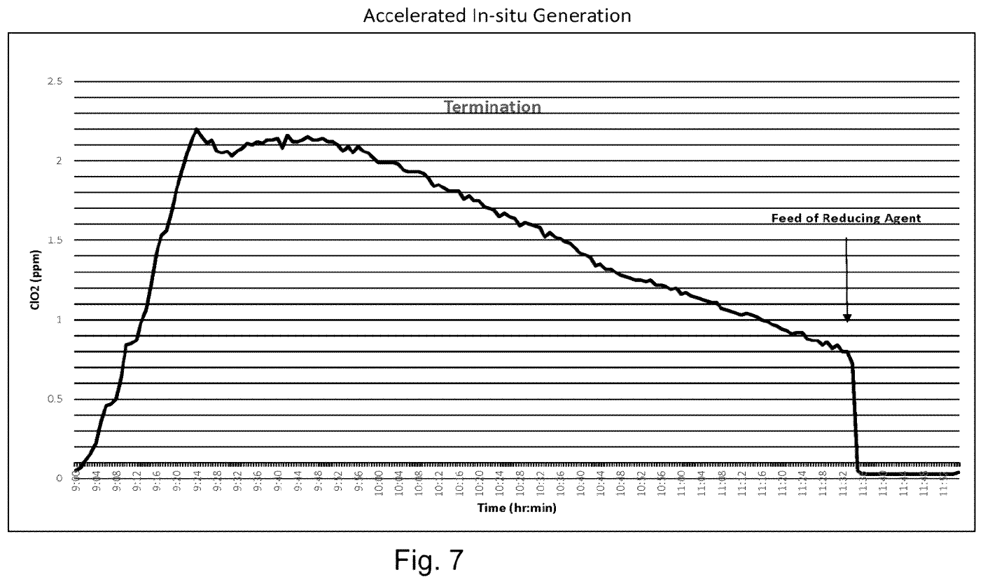

FIG. 8 illustrates a non-limiting example of an integrated system for controlling multiple remediation cycles using Accelerated In-situ generation of chlorine dioxide like that disclosed in co-pending application Ser. No. 18/140,882.

FIG. 9 illustrates the effect of lag-time on the calculated chlorine dioxide Ct value. The figure illustrates that the calculated Ct Value would not begin increasing until T₁, when the chlorine dioxide concentration is measured. The sloping dashed line (T₂-T₀) illustrates how much impact the lag-time compensation of the invention has on accelerating the remediation cycle. The sloped dashed line represents the increasing chlorine dioxide concentration that occurs during the lag-time (T₁-T₀).

### DETAILED DESCRIPTION OF THE INVENTION

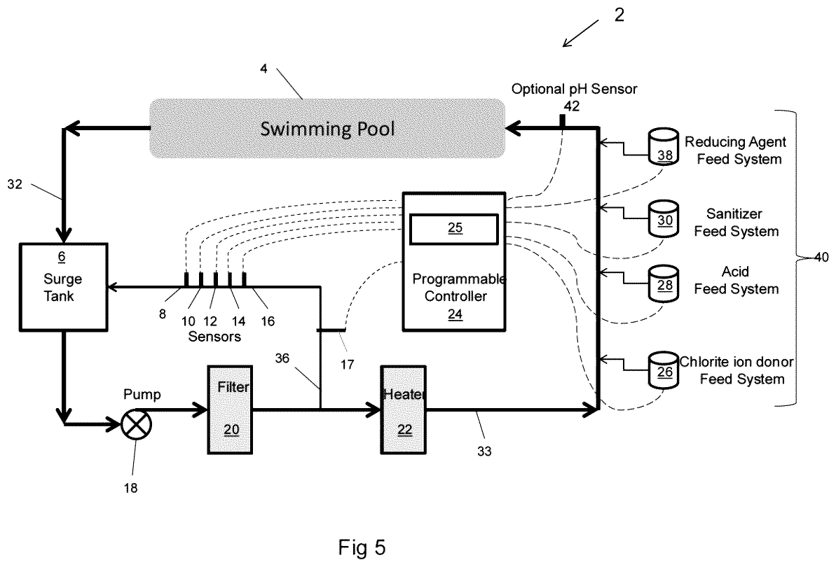

The invention will be explained with reference to attached non-limiting FIGS. FIG. 5 illustrates an exemplary integrated process control system 2 for controlling Recovery Remediation cycle for the treatment of the water 4 and circulating system 32, 6, 18, 20, 22, and 33 in an aquatic facility. In an aquatic facility, the water 4, such as in a swimming pool, typically flows out of the pool through exit conduit 32 to a surge tank 6, water pump 18, filter 20, heater 22, and then back into the pool via return conduit 33. A chemical feed system 40 is connected to the water 2, such as through the conduit 33. Examples of chemical feed systems 40 include a sanitizer feed system 30 for supplying sanitizer such as free halogen to the water 4, an acid feed system 28 for supplying chemicals to adjust or control the pH of the water 4, a chlorite donor feed system 26 for supplying chlorite ions to the water 4, and an optional reducing agent feed system 38 for supplying a reducing agent or other chemicals to the water 4.

A first sanitizer sensor 8 and a second sanitizer sensor 10 can be used to measure the relative concentration of sanitizer in the water 4. For example, the first sanitizer sensor 8 can be an ORP senor and the second sanitizer sensor 10 can be amperometric type sensor. A pH sensor 12 can be used to measure the pH of the water 4. A chlorine dioxide sensor 14 can be used to measure the concentration of chlorine dioxide in the water 4. A temperature sensor 16 can be used to measure the temperature of the water 4. A flow sensor 17 can be used to measure or indicate the water flow through the conduit 36 from which the sensors 8, 10, 12, 14, 16 and 17 are connected to sample the water 4.

A process controller 24 is used to control the water treatment of system 4. The chlorite donor feed system 26 (interchangeable with a chlorine dioxide generator), the acid feed system 28 and the sanitizer feed system 30 are connected to and controlled by the process controller 24. The sensors 8, 10, 12, 14, 16 and 17 are connected to and provide measurements to the process controller 24.

The invention comprises a system for controlling and accelerating Recovery Remediation cycles. The process controller is integrated with sensors for measuring critical water chemistry parameters and chemical feed systems for applying the chemicals. The process controller is programmed to apply and control the chlorine dioxide at different rates to achieve higher concentrations of chlorine dioxide in the case of a Recovery Remediation cycle and lower concentrations of chlorine dioxide in the case of Routine Remediation cycles. The ability to safely control a Routine Remediation cycle using continuous 24/7 treatment while bathers are present, then quickly implement a Recovery Remediation cycle that remediates the water in less than 30 minutes using the same integrated system provides owners, management and operators of Aquatic Facilities unprecedented capability, performance and water quality. Furthermore, since the majority of Aquatic Facilities already implement process control and chemical feed systems, an existing system can be upgraded with a kit making implementation low cost and readily available to the entire industry without expensive capital investment. Addition of a chlorine dioxide sensor, a chemical feeder for applying sodium chlorite (or a chlorine dioxide generator for ex-situ generation) and inserting a chip programmed to control Multiple Remediation cycles into the existing process controller is all that is needed to transform a traditional controller for controlling pH and disinfectant into a system capable of controlling multiple remediation cycles, thereby having the ability to irradicate Recreational Water illness (RWI).

The Florida Department of Health pH range for the water 4 of an aquatic facility is from 7.2 to 7.8 with the recommended range being 7.4 to 7.6. The programmable process controller 24 automatically monitors and controls the pH to operate within these ranges using the pH sensor 12 and acid feed system 28. Due to the significant lag time between the time of feeding pH related chemicals (i.e. acid) from the acid feed system 28 and the time to return a representative sample for the pH sensor 12 to measure, control logic is used to minimize the potential for overfeed of the chemical. Examples of control logic is on/off control and time-based proportioned control.

The Florida Department of Health Sanitizer range for chlorine (reported as Cl₂) sanitizer is from 1-10 ppm in pools and 2-10 ppm in spas. For bromine (reported as Br₂) the range is 1.5-10 ppm in pools and 3-10 ppm in spas.

During Routine Remediation comprising Daily Remediation, the water is treated with mixed oxidants in the evening when the swimming pool is closed. When the swimming pool is opened to bathers there may be some residual chlorine dioxide from the evening remediation, but during the remainder of the day the water is treated with only free chlorine and/or free bromine.

During Routine Remediation comprising Continuous 24/7 Remediation, the water is treated with mixed oxidants comprising chlorine dioxide and free chlorine and/or free bromine. The combination of mixed oxidants provides allows for operating with the free halogen concentration at the lower range, near 1.0 ppm as Cl₂ as the chlorine dioxide provides additional biocidal efficacy as a powerful disinfectant.

The process controller 24 tracks the chlorine dioxide concentration measured by the chlorine dioxide sensor 14 during the Continuous 24/7 Remediation and calculates the rolling average (also referred to as a “moving average”). The rolling average is multiplied by the time that has lapsed measured in minutes to update the chlorine dioxide Ct value in real-time. The rolling average can be updated over any desired period of lapsed time. One preferred period of lapsed time ranges from 0.1 to 60 minutes, more preferred 0.2 to 30 minutes, and most preferred 0.5 to 10 minutes. The ability to frequently update the real-time chlorine dioxide Ct value allows the process controller to forecast the trend and project when the targeted chlorine dioxide Ct value will be reached. Once the targeted chlorine dioxide Ct value is achieved, the process controller records the value and the time it was achieved. The process controller then resets the chlorine dioxide Ct value to zero (0), then repeats the process.

The process controller 24 can be configured to calculate, record, and store the chlorine dioxide Ct value. Optionally the controller 24 can display the chlorine dioxide Ct value on the display 25 and callout to a technician in the event of a successful or failed remediation cycle. Once the chlorine dioxide Ct value has been achieved, the process controller records the chlorine dioxide Ct value and the time it was achieved, resets the chlorine dioxide Ct value to zero (0), then repeats the process.

When electrolysis of chloride salts is used to generate free halogen (sanitizer), additional acid 28 may not be required. Electrolysis produces chlorine gas (Cl₂) which hydrolyses to form hypochlorous acid (HOCl) and hydrochloric acid (HCl).

When applying chlorine dioxide using in-situ generation, the simultaneous chemical feed of free halogen and acid from an electrolysis device (chlorine generator) and chlorite donor achieve localized high concentrations in the conduit. Fluid dynamics within the conduit combine the high concentrations of chemicals to induce a high rate of reaction resulting in elevated concentrations of chlorine dioxide in the conduit without the feed of additional acid from the acid feed system 28. The optimization of acid feed may be further improved by implementing a pH sensor into the conduit 42 that is in fluid contact with the process controller that can automatically adjust the acid feed 28.

When applying chlorine dioxide using ex-situ generation from a chlorine dioxide generator, the chlorite donor 26 is the chlorine dioxide applied from the chlorine dioxide generator.

A reducing feed system 38 interfaced with the process controller 24 and in fluid contact with the water 4 of the aquatic facility provides the ability to feed a reducing agent exemplified by sodium thiosulfate in order to neutralize any excess sanitizer after a Recovery Remediation cycle.

Once the target chlorine dioxide Ct value is achieved the remediation cycle can be terminated. The process controller can be programmed to automatically feed a reducing agent to the water based on the excess residual chlorine dioxide, oxidizer and/or sanitizer in the water. The approximate concentrations of residuals can be determined by either direct measurements utilizing amperometric and chlorine dioxide sensors and/or by calculation.

Calculated residuals can be determined by knowing the relative amounts of chlorite ions and oxidizer/sanitizer applied to the swimming pool. Knowing the relative amounts of each said chemical allows for approximating the amount of reducing agent needed to neutralize the excess residuals and accelerate the process of achieving compliance with the Dept of Health regulations to reopen the pool for use.

The remediation cycle is based on achieving a chlorine dioxide CT Value reported as mg/l×min.

Recovery Remediation comprises a Biofilm Remediation performed at the startup to remove the existing accumulated microbial (biofilm and/or Cryptosporidium) and chemical contaminants (e.g. enzymes, DBPs), and Shock Remediation performed after a known or suspected fecal release that is suspected of Cryptosporidium.

For Bio-film Remediation within the circulating system and achieving ≥6-log reduction of the entrapped bacteria, the chlorine dioxide CT Value ranges between 300 to 3000 (mg/l×min), more preferred 400 to 2500 (mg/l×min) and most preferred 500 to 2000 (mg/l/min).

For Shock Remediation Cryptosporidium in the water of an Aquatic Facility, the chlorine dioxide CT Value ranges between 80 to 400 (mg/l×min), more preferred 90 to 350 (mg/l×min) and most preferred 100 to 300 (mg/l/min).

Remediation of Cryptosporidium after a known or suspected fecal release and for bio-film remove from the circulating system is best achieved by applying a high concentrations of chlorine dioxide in the form of a shock treatment. For a Recovery Remediation cycle the chlorine dioxide setpoint ranges from 2 to 20 ppm, more preferred 3 to 15 ppm and most preferred 4 to 10 ppm.

Contaminants are routinely being added to the water of the Aquatic Facility while bathers are present. The mechanisms that lead to suppression of ORP and subsequent formation of biofilms are ongoing. Furthermore, the potential for an undetected release of Cryptosporidium from an infected person is always present as documented infections occur in treated recreational water every year. To minimize the potential for the onset and accumulation of biofilm and/or infections resulting from an undetected release of Cryptosporidium into the water, Routine Remediation cycles are performed.

Routine Remediation cycles comprise either Daily Remediation cycles or Continuous 24/7 Remediation cycles are employed as a form of prophylactic.

Routine Remediation cycles require low concentrations of chlorine dioxide. For Daily Remediation cycles or Continuous 24/7 Remediation cycles the chlorine dioxide setpoint ranges from 0.2 to 1 ppm, more preferred 0.2 to 0.8 ppm and most preferred 0.3 to 0.8 ppm.

For Routine Remediation cycles, the chlorine dioxide Ct Value ranges between 80 to 400 (mg/l×min), more preferred 90 to 300 (mg/l×min) and most preferred 100 to 250 (mg/l/min).

Implementation of Recovery Remediation cycles and Routine Remediation cycles can safely and effectively eliminate 100% of infections resulting from waterborne pathogens as well as Recreational Water Illness as disclosed by the Centers for Disease Control and Prevention.

The following terms used throughout the specification have the following meanings unless otherwise indicated.

“A” or “an” means “at least one” or “one or more” unless otherwise indicated.

“Comprise”, “have”, “include” and “contain” (and their variants) are open-ended linking verbs and allow the addition of other elements when used in a claim. “Consisting of” is closed, and excludes all additional elements.

“Consisting essentially of” excludes additional material elements, but allows the inclusions of non-material elements that do not substantially change the nature of the invention.

When referring to a group, “at least one . . . and . . . ” in the specification and claims is synonymous with “and/or”. For example, “at least one of A, B and C” means A alone, B alone, C alone, or any combination of A, B or C.

As used herein, “Remedial time-based proportional control” also “Remedial TBP” comprises a modified version of time-based proportional control that is configured to compensate for the high output ClO₂ feed systems required for the Recovery Remediation cycles and the subtle ClO₂ demands required by the Routine Remediation cycles, thereby allowing a single integrated chemical feed and process control system to effectively control Multiple Methods of Remediation cycles while operating within the completion time interval and ClO₂ Setpoint ranges established for the various methods.

Remedial time-based proportional control determines the chlorine dioxide feed system(s) ON-time following the equation:

$$[ \frac{{ClO}_{2} Setpoint ( ppm ) - Measured {ClO}_{2} ( ppm )}{{ClO}_{2} Dynamic \times 10 \times Dynamic Compensation} ] \times Time Segment = ON Time$$

where,
“Time Segment” is a segment of time reported in seconds or minutes (i.e. 60 seconds),
“ClO₂ Setpoint (ppm)” is the ClO₂ Setpoint for the selected remediation cycle,
“Measured ClO₂ (ppm)” is the ClO₂ value measured by the ClO₂ sensor,
“ClO₂ Dynamic” is the concentration of ClO₂ being applied to the water and is based on the total volume of water being treated per unit time (ClO₂ ppm/minute),
“Dynamic Compensation” (DC) is a unique value for each aquatic facility and compensates effects of lag-time on measurement of the chlorine dioxide concentration in the water by the chlorine dioxide sensor after chlorine dioxide has been fed to the water from the chlorine dioxide feed system, and the DC has a value ranging from 0.2 to 2.0.

As used herein, “Completion time interval” is the lapsed time from when the remediation cycle was initiated to when the targeted chlorine dioxide Ct Value is reached. Once the targeted Ct Value is reached, the remediation cycle is completed.

As used herein, “ClO₂ Dynamic” is the concentration of ClO₂ being applied to the water and is based on the total volume of water being treated per unit time (ClO₂ ppm/minute).

As used herein, “segment of time” is a period of time (exemplified by 60 seconds) used in determining the On-Time used for controlling the chlorine dioxide feed system.

As used herein, “minimum ON-Time” is a predetermined minimum period of time the chemical feed system will be turned ON. The minimum ON-Time overrides the On-Time value determined by the algorithm used to calculate the ON-Time if the calculated ON-Time value is lower than the minimum ON-Time. The use of the minimum ON-Time is used to prevent extremely short On-Time cycles (i.e. 1 second) that could potentially compromise the ability to properly control the chemical concentration due to mechanical limitations with the actuation of the chemical feed systems. Minimum ON-Time can be selected from about 1 to 5 seconds, and more preferred 2 to 4 seconds.

As used herein, “lag-time” is the time lapse (delay) from the time the chemical (i.e. chlorine dioxide) is applied to the water by the chemical feed system, to the time the sensor measures an increase in the chemical. For example, chlorine dioxide is applied to the water in conduit 33 that enters the swimming pool water 4. The chlorine dioxide disperses in the water and eventually some of the chlorine dioxide is taken into conduit 32 and supplied to conduit 36 where it is detected by the chlorine dioxide sensor 14. The time that lapsed between the application of chlorine dioxide to the time it was measured by sensor 14 is the lag-time.

As used herein, “Dynamic Compensation” also referred to as “DC” is swimming pool specific and compensates for the effect lag-time imparts on the measurement of ClO₂ by the chlorine dioxide sensor 14. DC is affected by turnover rate and has a value ranging from 0.2 to 2.0, with a default value of 1.0. The DC can be automatically adjusted by the process controller or can be manually input. The DC is particularly useful when the chemical feed systems impart a high ClO₂ Dynamic. DC can be automatically optimized using artificial intelligence (AI), wherein the AI tracks uses the lag-time and the amount (ppm) of chlorine dioxide overfeed. By monitoring these values, the AI can simulate adjustments to the DC (Optimized Value) and hone in the optimum Dynamic Compensation.

As used herein, “DC (Optimized Value)” is the Dynamic Compensation value resulting from the formula:

$$D C ( Optimized Value ) = Theoretical {ClO}_{2} ( ppm ) increase / Deviation from Setpoint ( ppm ) \times Y$$

Where,
“Theoretical ClO₂ (ppm) increase”=(ON-Time/lag-time)×ClO₂ Dynamic
“Deviation from Setpoint”=ClO₂ Setpoint−Measured ClO₂
“Y” is the “Lag-time Adjustment” having a value ranging from 1.01 to 2.0, preferably 1.05 to 1.8, and most preferred 1.1 to 1.5.

The DC (Optimized Value) corrects for the site-specific effect of lag-time and tightens the ability of the integrated chemical feed and process control system to hone in on the ClO₂ Setpoint.

As used herein, “chlorine dioxide feed system(s)” is used to describe the chemical feed systems used to apply chlorine dioxide to the swimming pool water 4, and is often used in the context of controlling the feed systems using time-based proportional control. Chlorine dioxide chemical feed system(s) may comprise the chlorite ion donor feed system 26, acid feed system 28 and sanitizer feed system 30 when the chlorine dioxide is produced using in-situ generation. In the case where the chlorine dioxide is generated using a chlorine dioxide generator (chlorite ion donor) 26 represents the chlorine dioxide generator with chlorine dioxide being a chlorite ion donor.

As used herein, “sanitizer” also “free halogen sanitizer” describes free chlorine and/or free bromine. Sanitizer is interchangeable with disinfectant as the free chlorine and/or free bromine also kill virus, but sanitizer is often used as bacteria is the prominent microbiological contaminant tested for by the local Departments of Health.

As used herein, “setpoint” describes a targeted value (also referred to as “setpoint value”) the process controller tries to sustain. The setpoint is also used by the programmable control to compare to the measured value to determine how aggressively (ON-Time duration) to apply additional chemical treatments for pH control, chlorine dioxide and free halogen.

As used herein, the term “aquatic facility” is used with reference to all structural components and equipment comprising the swimming pool, piping, pumps, filter and heater to contain, circulate and treat the water used by humans and/or other mammals for swimming, exercise, sports and recreation. Examples of aquatic facilities include but are not limited to: water parks, feature pools, swimming pools, spas, therapy pools, hot tubs and other structures containing water for immersion by humans or mammals.

As used herein, the term “aqueous system” describes a body of water 4 that can be treated using the disclosed invention.

As used herein, “recreational water” is water 4 used by humans and/or mammals for various activities such as swimming, exercise, water sports, recreation, physical therapy and diving. Examples of recreational water include: swimming pools, hot tubs, feature pools, spas, water-park rides, therapy pools, diving wells, and other structures containing water for immersion by humans or mammals.

As used herein the term “chlorine dioxide Ct value” is defined as the product of the average concentration of chlorine dioxide (mg/l) and time (minutes) of exposure to the chlorine dioxide. For example, if the average chlorine dioxide concentration of ClO₂ is determined to be 2.2 mg/l over a 20 minute period of time, the chlorine dioxide Ct value is calculated by multiplying the average concentration of chlorine dioxide by the time.

$$Chlorine dioxide Ct value = 2.2 mg / l \times 20 min$$

$$Chlorine dioxide Ct value = 44 ( mg / l \times min )$$

As used herein, chlorine dioxide Ct value setpoint (mg/l×min) is the setpoint having the units “mg/l×minutes” that when achieved terminates the remediation cycle.

As used herein, “algorithm to calculate the chlorine dioxide Ct value” describes a mathematical equation for calculating the chlorine dioxide Ct value in near real-time. One example of a suitable algorithm for calculating the chlorine dioxide Ct value follows:

$$Chlorine dioxide Ct value = [ ( \sum {X}_{n} ) \div n ] \times T$$

Where:
“Xn” is the chlorine dioxide concentration in mg/l (or ppm) recorded at a point in time since beginning the remediation cycle.
“n” is the number of chlorine dioxide values recorded over a period of time since beginning the remediation cycle.
“T” is the period of time (minutes) that has lapsed since beginning the remediation cycle.

As used herein, “rolling average” is the average chlorine dioxide concentration resulting from the accumulated (sum) chlorine dioxide concentrations (mg/l) divided by the number of chlorine dioxide measurements by the chlorine dioxide sensor 14 and recorded. The rolling average is used to provide a real-time chlorine dioxide Ct value by multiplying the rolling average by the lapsed time (i.e. number of minutes since beginning the calculation of the chlorine dioxide Ct value). The rolling average can be updated over any desired period of lapsed time. One preferred period of lapsed time ranges from 0.1 to 60 minutes, more preferred 0.2 to 30 minutes, and most preferred 0.5 to 10 minutes.

As used herein, the term “remediation cycle” describes the process of treating the water of an aquatic facility with chlorine dioxide, resulting in mixed halogen-based treatment comprising chlorine dioxide and free halogen to obtain a targeted chlorine dioxide Ct value (min×mg/l) to achieve remediation. Remediation cycles have the steps of initiation, implementation and termination when the targeted Ct Value is achieved.

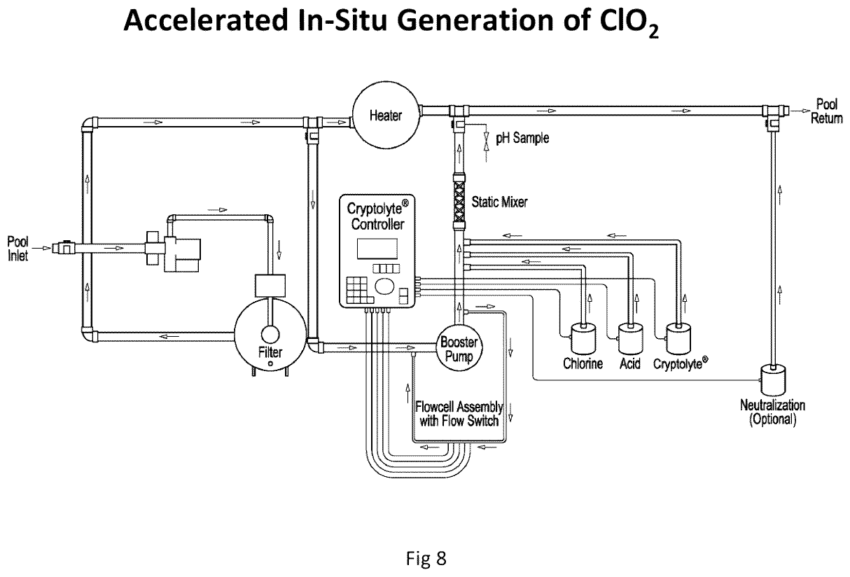

As used herein, “accelerated in-situ generation of chlorine dioxide” describes delivering chemicals for the in-situ generation of chlorine dioxide using methods disclosed in Co-pending application Ser. Nos. 17/866,823, 17/988,963 and 17/571,586 and exemplified in FIG. 8. Accelerated in-situ generation of chlorine dioxide comprises creating localized high concentrations of chemicals for generating chlorine dioxide. Accelerated in-situ generation of chlorine dioxide eliminates the need for a chlorine dioxide generator by using the existing conduit or a side-stream in fluid contact with the existing conduit of the pools circulating system.

As used herein, “localized high concentrations” refers to the concentration of chemicals used for the generation of chlorine dioxide within the conduit. The volume of water in the conduit is only a small portion of the volume of water in the swimming pool. When the said chemicals are applied to the conduit, the concentration in the conduit may be 100's of times higher than what will be achieved once the chemicals are dispersed in the large volume of water in the swimming pool. For example, a 100,000 gallon swimming pool is required to have a turnover every 6 hours or less to meet typical Dept of Health codes. A circulation rate of approximately 280 gpm is required. If the process controller is programmed to feed sufficient chemical to produce 5 ppm as ClO₂ based on the volume of water in the pool and the chemicals are feed over three minutes, the localized high concentrations within the conduit are sufficient to produce approximately 119 ppm as ClO₂. By utilizing accelerated in-situ generation of chlorine dioxide, localized high concentrations of reactant chemicals result in high conversion efficiency without the use of a chlorine dioxide generator.

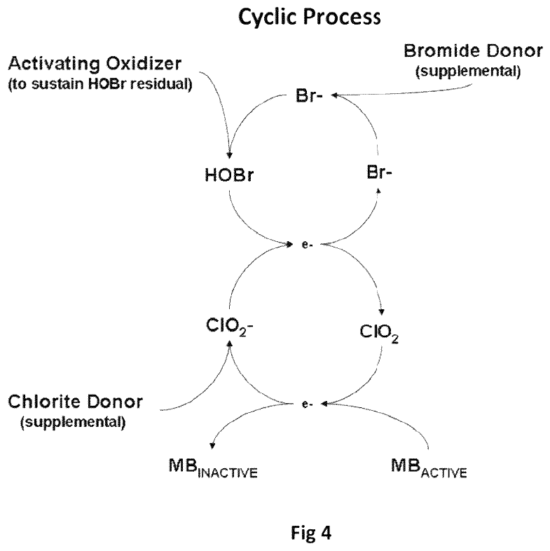

As used herein, the term “cyclic process” describes the in-situ generation of chlorine dioxide resulting from hypobromous acid activation of chlorite, followed by the recycling of substantially inert anions comprising bromide and chlorite. The bromide and chlorite are then oxidized into their oxyhalogen surrogates, exemplified by hypobromous acid and chlorine dioxide respectfully followed by reduction back to their respective anions, and where the process is repeated (FIG. 4). The cyclic process comprises activating bromide ions with the oxidant to produce free bromine, the free bromine oxidizes chlorite ions to produce chlorine dioxide, reducing at least some free bromine back to bromide ions and repeating the process. Chlorite ions resulting from the reduction of chlorine dioxide are also recycled back to chlorine dioxide in the cyclic process.

As used herein “hypobromous acid activation of chlorite” describes how the cyclic process in-situ generates chlorine dioxide from chlorite. The cyclic process as previously described in a multi-step process that makes efficient use of the chlorite. However, the in-situ generation of chlorine dioxide resulting from the cyclic process is the direct result of hypobromous acid activation of chlorite.

As used herein, “UV activation” and “UV activation of chlorite” is a method for in-situ generation of chlorine dioxide from chlorite that is especially suitable for outdoor pools during normal daylight hours when most recreational water facilities are being used by swimmers and bathers. The method exploits the benefits of sunlight's UV to accelerate the generation of chlorine dioxide. Addition of a chlorite donor to the aqueous system exposed to sunlight results in the in-situ generation of chlorine dioxide by ultraviolet (UV) light induced photolysis (decomposition) of chlorite ions according to the proposed stoichiometry:

3ClO₂⁻+H₂O+hv→Cl⁻+2ClO₂+2OH⁻+0.5O₂

This method of in-situ generating chlorine dioxide is beneficial while the pool is in use by applying chlorite into the pool thru the return ports of the circulating system. This eliminates the injection of chlorine dioxide gas into the pool while swimmers are present.

As used herein, the term “chlorite ion donor” and “chlorite donor” is a compound that comprises an alkali metal salt comprising chlorite anions ClO₂″, chlorine dioxide, or any convenient direct or indirect source of chlorite anions. For example, chlorine dioxide can indirectly produce chlorite due to its reduction in an aqueous system. Sodium chlorite directly supplies chlorite anions.

As used herein, the term “chlorite ion” and “chlorite anion” (also referred to as “chlorite”) comprises chlorite having the general formula ClO₂⁻. The chlorite is the anion released when sodium chlorite is dissolved in water and converts to chlorine dioxide.

As used herein, the term “recycled” means at least some portion of the recovered bromide ions and chlorite ions are regenerated to their respective oxyhalogen compounds, followed by reduction back to their respective anions, and where the process is repeated.

As used herein, the term “Cryptosporidium” is used to represent any form of parasitic microbiological organism from the family of Cryptosporidium. An example of Cryptosporidium is Cryptosporidium parvum (also referred to as C. parvum, C. parvum and Cryptosporidium parvum). Other examples of Cryptosporidium include but are not limited to: C. hominis, C. canis, C. felis, C. meleagridis, and C. muris. It is to be noted that inclusion or exclusion of italic characters or print when referring to Cryptosporidium or any of its many variants does not in any way detract from its intended descriptive meaning.

As used herein, the term “microbiological organisms” is used with reference to all forms of microbiological life including: parasites, bacteria, viruses, algae, fungus, and organisms encased in biofilms.

As used herein, “parasites” includes any species of organism including Cryptosporidium, Giardia and Ameba that can be transferred to humans by water and cause waterborne parasitic disease in humans.

As used herein, the term “inactivation” is used with reference to the ability to deactivate, kill, or destroy microbiological organisms.

As used herein, “remediation” is defined as the ability to reduce the level of waterborne pathogens and/or algae to levels at or below that deemed acceptable by various regulatory agencies exemplified by the Departments of Health, U.S. Environmental Protection Agency, and/or the Centers for Disease Control and Prevention. Examples of achieving remediation comprise at least one of the following: less than 1CFU per ml of viable bacteria determined by heterotrophic plate count; greater than or equal to a 3-log reduction of parasites such as Cryptosporidium, and/or rendering the aqueous system free of algae.

As used herein, “process controller” 24 describes a control system that interfaces with sensors and chemical feed systems for the chemical treatment of water of an Aquatic Facility.

Non-limiting examples of how the process controller 24 can be used to control chemical feed systems 40 includes: actuating chemical feed; varying the rate of chemical feed; energizing an electronic device such as a chemical feed pump, solenoid valve; stopping chemical feed; and initiating a neutralization cycle that removes residual chemicals from the water using neutralizing chemicals exemplified by sodium sulfite. The process controller 24 receives inputs either manually and/or automatically from sensors exemplified by the non-limiting examples: pH sensor 12, ORP sensor 8, amperometric sensor 10, chlorine dioxide sensor 14, temperature sensor 16, flow sensor 17, flow switch and the like.

The process controller 24 uses some form of control logic to control and optimize the feed of chemicals. Examples of control logic include: time-based proportional, proportional, on/off etc.

As used herein, “fluid contact” describes contact between conduits 32, 33 capable of transporting liquid to and from the main body of water (i.e. swimming pool) 4 at the aquatic facility. Specifically, regarding aquatic facilities, sensors and chemical feed systems 40 are in fluid contact with the water 4 of an aquatic facility in or near the mechanical room where water is recovered from the pool, filtered 20, sometime heated 22 and returned to the pool. The piping (conduit) 36 transporting the water supplies water for the sensors to monitor the various parameters such as pH 12, sanitizer concentration 8, 10, temperature 16 and chlorine dioxide 14. Chemical feed 40 is generally applied into the return piping 33 after being filtered and where applicable heated to prevent corrosion of the heater 22.

As used herein, “chemical feed systems” 40 describe any convenient device that is fluid contact with both the chemicals and the water of the aquatic facility. The chemical feed systems 40 can be controlled to deliver the desired amount of chemicals exemplified by the non-limiting examples chlorine, bromine, acid such as HCl or CO₂ and chlorite ion donor such as sodium chlorite and/or chlorine dioxide. Non-limiting examples of chemical feed systems include: chemical metering pumps, educators, modulating control valves, electrolysis device and the like.

As used herein, “flow sensor” 17 describes a device that can detect a liquid flowing through a pipe or conduit 36. The flow sensor 17 can be a flow transmitter that measures the flow rate, but is not required to measure the flow rate. The flow sensor 17 detects motive water in the pipe or conduit 36. One non-limiting example of a flow sensor that does not measure the flow rate is a Rotorflow® Flow Sensor available by Gems™ Sensors and Controls.

As used herein, “actuated” and “actuating” and its variations is an action initiated by the process controller 24 to cause something to happen such as initiating chemical feed, stopping chemical feed, initiating a neutralization cycle and the like.

As used herein, the term “free chlorine” describes the presence of hypochlorous acid and/or hypochlorite ions when a chlorine donor is dissolved in water. The predominant species of free chlorine is dependent on the pH of the water. At pool water pH of 7.2 to 7.8 free chlorine comprises both hypochlorous acid (HOCl) and hypochlorite ions (OCl⁻). However, when the pH is lowered with acid such as in the case of applying the accelerated in-situ generation of chlorine dioxide, the predominant species of free chlorine in the conduit of the circulating system is hypochlorous acid (HOCl). Sources of free chlorine include sodium hypochlorite, calcium hypochlorite, dichloroisocyanuric acid, trichloroisocyanuric acid, lithium hypochlorite as well as electrolysis devices the convert chloride ions to free chlorine in water.

As used herein, the term “free bromine” is used with reference to the formation or presence of hypobromous acid and possibly some portion of hypobromite ions, depending on the pH. At pool water pH most of the free bromine is hypobromous acid.

As used herein, the term “free halogen” is used with reference to a halogen-based sanitizer that hydrolyses into various halogen-based species when dissolved in water. Chlorine based free halogen comprises HOCl, and OCl⁻ (also referred to as free chlorine) when a chlorine donor is dissolved in water at pool water pH (7.2-7.8). Bromine based free halogen forms HOBr, and OBr⁻ (also referred to as free bromine), when a bromine donor is dissolved in water at pool water pH.

As used herein, the term “oxidizer” is used to describe a chemical capable of oxidizing bromide ions to form free bromine and/or chloride ions to free chlorine. The oxidizer can comprise bromide ions and/or free bromine. The oxidizer can be a sanitizer exemplified by calcium hypochlorite, sodium hypochlorite, lithium hypochlorite and the like. One non-limiting example of an oxidizer comprising bromide ion donor is TowerBrom® 90M sold by Occidental Chemical Corporation. Other non-limiting examples of oxidizers include potassium monopersulfate, trichloroisocyanurate, dichloroisocyanurate, 1-Bromo-3-chloro-5,5-dimethylhydantoin and the like. Electrolysis of chloride ions to produce free chlorine is also a suitable oxidizer.

As used herein, the term “inactivation” is used with reference to the ability to deactivate, kill, or destroy microbiological organisms.

As used herein, the term “microbiological organisms” is used with reference to all forms of microbiological life forms including: parasites, bacteria, viruses, algae, fungus, and organisms encased in biofilms.

As used herein, “sensor for controlling the feed of sanitizer” is used with reference to ORP and/or amperometric sensors that are in fluid contact with the water of an aquatic facility, and provide measurements used for controlling the feed of a sanitizer (e.g. chlorine and/or bromine). While only one sensor is used to control the sanitizer at any given time, it is beneficial to monitor both ORP and free chlorine.

As used herein, “amperometric sensor” 10 describes a device that is in fluid contact with the water of an aquatic facility and is used to measure the concentration of sanitizer exemplified by free chlorine. The amperometric sensor 10 can be used to control the feed of sanitizer.

As used herein, “chlorine dioxide sensor” 14 describes a device that is in fluid contact with the water 4 of an aquatic facility and is used to measure the chlorine dioxide concentrated used to remediate the aquatic facility. Generally, the chlorine dioxide sensor 14 is an amperometric sensor that incorporates a gas permeable membrane that allows chlorine dioxide gas to permeate the membrane while isolating the sensor from hydrolyzed oxidizers like chlorine. The chlorine dioxide sensor 14 can be any suitable sensor that can be used to selectively measure the chlorine dioxide. One example of another type of chlorine dioxide sensor is a colorimetric device that utilizes lissamine green reagents to selectively measure chlorine dioxide in the presence of sanitizers, or new technologies that use solid state sensors that are selective to chlorine dioxide.

As used herein, “ORP sensor” 8 describes a device that is in fluid contact with the water of an aquatic facility and is used to measure the Oxidation Reduction Potential (ORP) of the water 4. ORP sensor 8 can be sued to control the feed of sanitizer. The ORP sensor does not directly measure the presence of free halogen. The ORP sensor is influenced by contaminants in the water that impart an oxidant demand on the free halogen. Therefore, ORP is a means of determining the “relative concentration” of free halogen in the water. However, ORP is a very effective means of controlling the free halogen concentration for use as a sanitizer.

As used herein, “chemical feed systems” 40 describes in broad terms any desirable means for applying chemicals to the water 4 of an aquatic facility. Non-limiting examples of chemical feed systems include: chemical metering pumps, educators, erosion feeders such as a chlorinator or brominator, electrolysis device for producing chlorine from sodium chloride in the water and a chlorine dioxide generator for ex-situ generation of chlorine dioxide.

As used herein, “Heterotrophic plate count (HPC) is also known by a number of other names, including standard plate count, total plate count, total viable count or aerobic quality count. It does not differentiate between the types of bacteria present nor does it indicate the total number of bacteria present in the water-only those capable of forming visible colonies under specified conditions on certain non-selective microbiological media. Varying the incubation temperature will favor the growth of different groups of bacteria. As it gives more meaningful information about pathogenic (disease-causing) bacteria, 35° C. (or 37° C.) is the preferred incubation temperature. HPC does not necessarily indicate microbiological safety as the bacteria isolated may not have been faecally-derived but it does give a measure of the overall general quality of the pool water, and whether the filtration and disinfection systems are operating satisfactorily. Results reported by the laboratory are traditionally expressed as colony forming units per millilitre (CFU/mL) which equates to the number of bacteria in each millilitre of the original sample of water. A HPC count of less than 1 CFU/mL indicates that the disinfection system is effective. If the count is between 10 and 100 CFU/mL, a routine investigation should be conducted as soon as possible to ensure that all the management operations are functioning properly.

As used herein, “CFU” (Colony Forming Units) is a unit used in microbiology to estimate the number of viable bacteria or fungal cells in a sample.

Algorithms can be programmed into the process controller for achieving compliance with the Dept of Health regulations for swimming pool water quality. Once the sensors detect the swimming pool water is within the compliance, process controller can notify the appropriate personnel that the pool is ready for use by patrons. Controller display can signal the pool is ready for opening and/or remote communications can notify managers via a call or an app to their phones or computers.

### Example

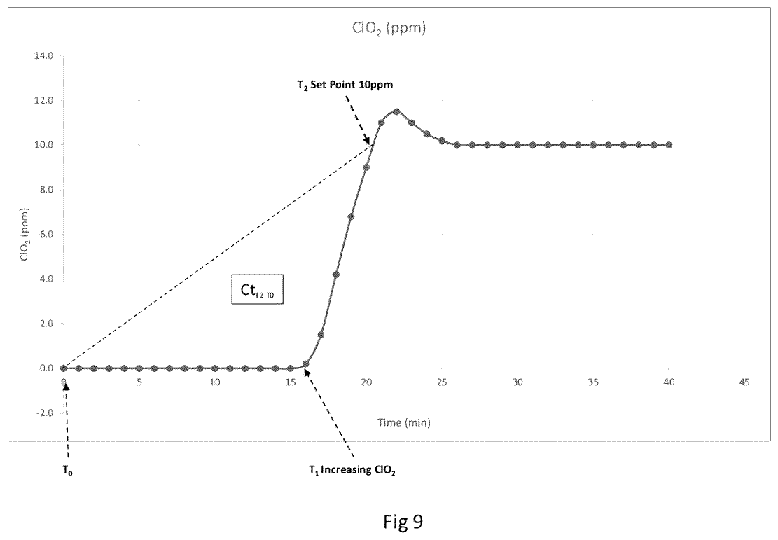

Referring to FIG. 9, the normal operation of a Recover Remediation after a fecal release is represented by the solid line with dots noting the time increments in minutes. The graph illustrates the normal duration to achieve a Ct Value of 160 mg/l×min would be approximately 34 minutes from the initiation of the Recovery Remediation cycle. In contrast, when the lag-time compensated chlorine dioxide Ct Value is employed, the graph illustrate the same 160 Ct Value would be completed in just 26 minutes, a 24% reduction in the time to complete the remediation cycle.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

1. A method for accelerating a recovery remediation cycle of water at an aquatic facility for immersion by humans, the method comprising:
providing an integrated system comprising:
a chlorine dioxide sensor in fluid communication with the water;
a chlorine dioxide feed system in fluid communication with the water; and
a process controller in communication with the chlorine dioxide sensor and the chlorine dioxide feed system for measurement and control of chlorine dioxide in the water, wherein the process controller having a chlorine dioxide setpoint and a chlorine dioxide Ct value setpoint (milligram/liter×minutes);
initiating the recovery remediation cycle;
the process controller feeding the chlorine dioxide from the chlorine dioxide feed system to the water;
the process controller measuring a chlorine dioxide concentration in the water using the chlorine dioxide sensor;
the process controller calculating the chlorine dioxide Ct value until the chlorine dioxide Ct value setpoint is reached;
when a chlorine dioxide setpoint is reached, the process controller calculating a lag-time compensated chlorine dioxide Ct value of the water using the following steps:
subtracting a T₀ chlorine dioxide concentration of the water from a T₂ chlorine dioxide concentration of the water by the process controller to obtain the delta chlorine dioxide concentration;
dividing a delta chlorine dioxide concentration by 2 by the process controller to obtain an average chlorine dioxide concentration;
multiplying the average chlorine dioxide concentration by a time period T₂-T₀ (minutes) by the process controller to obtain a lag-time compensated chlorine dioxide Ct value, wherein T₀ is the time when the recovery remediation cycle is initiated, T₂ is the time lapsed (minutes) when the chlorine dioxide setpoint is reached, and the lag-time compensated chlorine dioxide Ct value reduces time to complete the recovery remediation cycle;
the process controller replacing the calculated chlorine dioxide Ct value with the lag-time compensated chlorine dioxide Ct Value and continuing to calculate the chlorine dioxide Ct value, and
when the chlorine dioxide Ct value setpoint is reached the remediation cycle is terminated by the process controller.

2. The method in accordance with claim 1, wherein the T₀ chlorine dioxide concentration is 0 ppm.

3. A system for accelerating the recovery remediation cycle for the treatment of water of an aquatic facility for immersion by humans, the system comprising:
a chlorine dioxide sensor in fluid communication with the water;
a chlorine dioxide feed system in fluid communication with the water; and
a process controller in communication with the chlorine dioxide sensor and the chlorine dioxide feed system for measurement and control of chlorine dioxide in the water;
the process controller is programmed to control the recovery remediation cycle comprising the steps;
having a chlorine dioxide Ct value setpoint (milligram/liter×minutes);
initiating the recovery remediation cycle;
measuring the lapsed time;
measuring the chlorine dioxide concentration;
calculating a lag-time compensated chlorine dioxide Ct value of the water:
sustaining the concentration of chlorine dioxide until the chlorine dioxide Ct value setpoint of the water is achieved; and
the process controller stopping feeding of the chlorine dioxide from the chlorine dioxide feed system to the water when the chlorine dioxide Ct value setpoint of the water is achieved.

4. The system in accordance with claim 3, wherein the lag-time compensated chlorine dioxide Ct value comprises:
subtracting the T₀ chlorine dioxide concentration from the T₂ chlorine dioxide concentration to obtain the delta chlorine dioxide concentration;
dividing the delta chlorine dioxide concentration by 2 to obtain the average chlorine dioxide concentration;
multiplying the average chlorine dioxide concentration by the time period T₂-T₀ (minutes) to obtain the lag-time compensated chlorine dioxide Ct value; and
T₀ is the time when the recovery remediation cycle is initiated, and T₂ is the time lapsed (minutes) when the chlorine dioxide setpoint is reached, wherein the lag-time compensated chlorine dioxide Ct value reduces the time to complete the recovery remediation cycle.

5. The system in accordance with claim 3, wherein the process controller recording the time when the lag-time compensated chlorine dioxide Ct value is achieved and terminating the remediation cycle.

6. The invention in accordance with claim 4, wherein the T₀ chlorine dioxide concentration is 0 ppm.

7. A system for accelerating a recovery remediation cycle of water at an aquatic facility for immersion by humans comprising:
a chlorine dioxide sensor in fluid communication with the water;
a chlorine dioxide feed system in fluid communication with the water; and
a process controller in communication with the chlorine dioxide sensor and the chlorine dioxide feed system for measurement and control of chlorine dioxide in the water;
wherein the process controller is programmed to have a chlorine dioxide setpoint and a chlorine dioxide Ct value setpoint (milligram/liter×minutes);
wherein the process controller is programmed to perform the following steps:
feeding the chlorine dioxide from the chlorine dioxide feed system to the water;
measuring a chlorine dioxide concentration in the water using the chlorine dioxide sensor;
calculating the chlorine dioxide Ct value until the chlorine dioxide Ct value setpoint is reached;
when a chlorine dioxide setpoint is reached, calculating a lag-time compensated chlorine dioxide Ct value of the water using the following steps:
subtracting a T₀ chlorine dioxide concentration of the water from a T₂ chlorine dioxide concentration of the water by the process controller to obtain the delta chlorine dioxide concentration;
dividing a delta chlorine dioxide concentration by 2 by the process controller to obtain an average chlorine dioxide concentration;
multiplying the average chlorine dioxide concentration by a time period T₂-T₀ (minutes) by the process controller to obtain a lag-time compensated chlorine dioxide Ct value, wherein T₀ is the time when the recovery remediation cycle is initiated, T₂ is the time lapsed (minutes) when the chlorine dioxide setpoint is reached, and the lag-time compensated chlorine dioxide Ct value reduces time to complete the recovery remediation cycle;
replacing the calculated chlorine dioxide Ct value with the lag-time compensated chlorine dioxide Ct Value and continuing to calculate the chlorine dioxide Ct value, and
when the chlorine dioxide Ct value setpoint is reached the remediation cycle is terminated.
